(19) United States
(12) Patent Application Publication
(10) Pub. No.: US 2020/0073485 A1
(43) Pub. Date: Mar. 5, 2020

(54) EMOJI PREDICTION AND VISUAL SENTIMENT ANALYSIS

(71) Applicant: Twitter, Inc., San Francisco, CA (US)

(72) Inventors: Ziad Al-Halah, London (GB); Andrew P. Aitken, London (GB); Wenzhe Shi, London (GB); Jose Caballero, London (GB)

(21) Appl. No.: 16/561,629

(22) Filed: Sep. 5, 2019

Related U.S. Application Data
(60) Provisional application No. 62/727,202, filed on Sep. 5, 2018.

(51) Int. Cl. G06F 3/023; G06N 20/00; G06N 3/08; G06F 16/583; G06F 16/538

(52) U.S. Cl. CPC G06F 3/0237; G06N 20/00; G06F 16/538; G06F 16/5846; G06N 3/08

(57) ABSTRACT

Systems and methods for emoji prediction and visual sentiment analysis are provided. An example system includes a computer-implemented method. The method may be used to predict emoji or analyze sentiment for an input image. An example method includes the step of receiving an image. The example method further includes the steps of generating an emoji embedding for the image and generating a sentiment label for the image using the emoji embedding. The emoji embedding may be generated using a machine learning model.

### CROSS-REFERENCE TO RELATED APPLICATION

This application is a Nonprovisional of, and claims priority to, U.S. Patent Application No. 62/727,202, filed on Sep. 5, 2018, entitled “EMOJI PREDICTION FOR VISUAL SENTIMENT ANALYSIS”, which is incorporated by reference herein in its entirety.

### BACKGROUND

Analyzing people's emotions, opinions, and attitudes towards a specific entity, an event, or a product is referred to as sentiment analysis. Sentiment can be reduced to positive, neutral, and negative, or can be extended to a richer description of fine-grained emotions, such as happiness, sadness, or fear.

### SUMMARY

Implementations relate to machine learning models for emoji prediction and visual sentiment analysis. For example, an emoji-based embedding for cross-domain sentiment and emotion analysis may be learned.

One aspect is a computer-implemented method comprising receiving an image; generating an emoji embedding for the image; and generating a sentiment label for the image using the emoji embedding.

Implementations can include one or more of the following features. The generating an emoji embedding for the image can include applying an emoji embedding model to the image. The emoji embedding model can be a machine learning model. The emoji embedding model can be an artificial neural network model. The artificial neural network model can include a residual neural network. The artificial neural network model can include a deep residual neural network having at least ten layers. The artificial neural network model can include a deep residual neural network having at least fifty layers. The machine learning model can be generated using a training process on a corpus of annotated image data. The corpus of annotated image data can include images that are annotated with at least one emoji. The corpus of annotated image data can be generated from social media data. The corpus of annotated image data is generated automatically from social media data. The emoji embedding can include a vector of values, the different values in the vector corresponding to different emoji. The generating a sentiment label for the image using the emoji embedding can include determining a positive, negative, or neutral sentiment value for the image. The generating a sentiment label for the image using the emoji embedding can include applying an emoji-to-sentiment model to the emoji embedding. The emoji-to-sentiment model can be generated using a training process on a corpus of labeled image data. The corpus of labeled image data can include images annotated with at least one sentiment value. The emoji-to-sentiment model can be zero-shot model that is generated without use of training images. The method can further include generating a suggested caption for the image based on the emoji embedding. The method can include triggering display of an indication of the determined sentiment label for the image.

Another aspect is a system comprising: at least one memory including instructions; and at least one processor that is operably coupled to the at least one memory and that is arranged and configured to execute instructions that, when executed, cause the at least one processor: acquire annotated image data; apply exclusion criteria to the acquired annotated image data; select acquired image data with annotations that include specific emoji; and temporally sample the selected acquired image data.

Implementations can include the following feature. The instructions that, when executed, cause the at least one processor to acquire annotated image data can include instructions to acquire social media posts that include images and emoji. The instructions that, when executed, cause the at least one processor to apply exclusion criteria to the acquired annotated image data can include instructions to remove social media posts that include uniform resource locators from the acquired annotated image data. The social media posts can be associated with a date. The instructions that, when executed, cause the at least one processor to temporally sample the selected acquired image data can include instructions to: determine a longer time period; divide the longer time periods into a plurality of shorter time windows, the plurality of shorter time windows including a first time window and second time window; identify a predetermined number of social media posts associated with dates occurring in the first time window, the identified social media posts including a specific emoji; and identify a predetermined number of social media posts associated with dates occurring in the second time window, the identified social media posts including the specific emoji. The instructions can further cause the system to train an emoji embedding model using the identified social media posts associated with dates occurring in the first time window and the identified social media posts associated with dates occurring in the second time window.

Another aspect is a non-transitory computer readable storage medium including instructions that when executed by at least one processor, cause the at least one processor to: receive an image; generate an emoji embedding for the image by applying a machine learning model to the image, the emoji embedding including a vector of values, the different values of the vector corresponding to different emojis; and predicting at least one emoji for the image based on the emoji embedding. Implementations can include the following feature. The instructions can further cause the at least one processor to: generate a sentiment label for the image using the emoji embedding; and trigger display of an indication of the sentiment label for the image.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations and wherein:

FIG. 1 illustrates a schematic block diagram of an example system usable for emoji prediction and visual sentiment analysis.

FIG. 2 illustrates a block diagram of a method according to at least one example embodiment.

FIG. 3A illustrates example emoji that represent objects.

FIG. 3B illustrates example emoji that represent abstract concepts.

FIG. 3C illustrates example emoji that represent animals or plants.

FIG. 4 illustrates an example subset of emoji that may commonly be associated with expression of sentiment.

FIG. 5A illustrates a graph of the distribution of emoji in an example image training set.

FIG. 5B illustrates a graph of the distribution of emoji in an example image training set when temporal sampling is used.

FIGS. 6A and 6B illustrate example groups of related emoji.

FIG. 7 illustrates a block diagram of a method according to at least one example embodiment.

FIG. 8 illustrates a block diagram of a method according to at least one example embodiment.

FIG. 9 illustrates a diagrammatic representation of a machine in the example form of a computing device within which a set of instructions, for causing the machine to perform any one or more of the methodologies discussed herein, may be executed.

It should be noted that these figures are intended to illustrate the general characteristics of methods, structure and/or materials utilized in certain example implementations and to supplement the written description provided below. These drawings are not, however, to scale and may not precisely reflect the precise structural or performance characteristics of any given implementation, and should not be interpreted as defining or limiting the range of values or properties encompassed by example implementations. The use of similar or identical reference numbers in the various drawings is intended to indicate the presence of a similar or identical element or feature.

### DETAILED DESCRIPTION

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Summarizing and understanding sentiment has important applications in various fields like interpretation of customer reviews, advertising, politics, and social studies. Implementations of the techniques described herein may enable or perform such applications or other applications.

Driven by the availability of large-scale annotated datasets along with modern deep learning models, language sentiment analysis witnessed great improvements over the last few years. However, visual sentiment analysis still lags behind. One of the reasons that visual sentiment analysis lags behind language sentiment analysis is the unavailability of large-scale image datasets with sentiment labels. Current datasets are scarce and too small to appropriately train deep neural networks, which are prone to overfitting on small training datasets. Most available datasets are small and contain only hundreds or a few thousand samples. Collecting data for a large enough training set for visual sentiment analysis may be expensive, time-consuming, or impractical.

Instead, the current dominant approach to visual sentiment analysis is to employ cross-domain transfer learning methods. This is achieved by pretraining a deep neural network on an existing large-scale dataset for visual object classification, such as ImageNet (which includes millions of labeled images of objects), and then fine-tuning the network for sentiment classification on the small target dataset that includes sentiment labels. However, object categories and sentiment labels are not aligned and are instead orthogonal. Object labels are often sentiment neutral; i.e. objects of the same category can exhibit various emotions (e.g., an infant in a picture may be happy or angry, or a picture of a dog may joyful or sad). Hence, the domain gap between object recognition and sentiment analysis is significant. Pretraining a model with an object-focused embedding may not be the most useful representation for subsequent transfer learning for sentiment or emotion classification.

Many visual sentiment methods rely on hand-crafted features (e.g. color histograms, SIFT) to train simple models with few parameters in order to avoid the risk of overfitting the training data. However, it is hard for such low-level features to effectively capture the higher-level concept of sentiment.

One way to overcome the previous problem is by learning an intermediate representation from external data that helps to bridge the gap between low-level features and sentiment. For example, this can be achieved by learning an intermediate concept classifier for Adjective Noun Pairs (ANP) as in the SentiBank model. However, the most common approach is to take advantage of powerful models, i.e., deep neural networks, in a transfer learning setting. In this case, the neural network model is initially trained on a large-scale dataset for object classification. Afterwards, the model is fine-tuned on the target task for sentiment prediction.

However, while ANP-based and object-based embedding lead to improved performance, both are still not ideal for sentiment analysis. It is not clear how to select a good ANP vocabulary that can generalize well to various tasks requiring the inference of emotions from images. Additionally, object-based models are not suited for capturing sentiment since they are trained for sentiment neutral object classification.

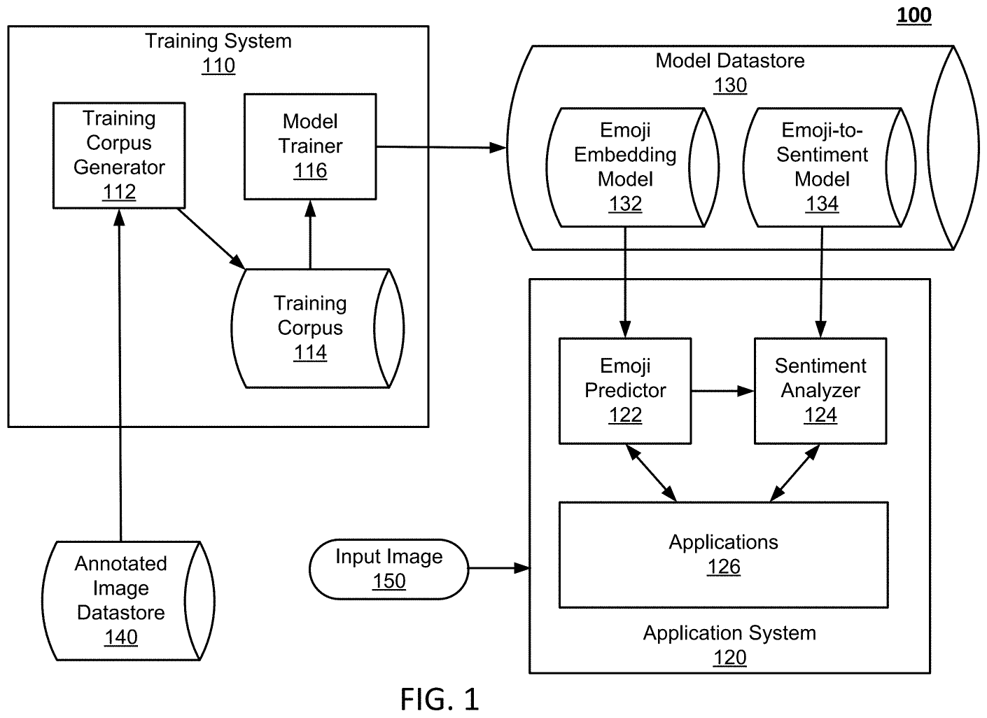

FIG. 1 illustrates a schematic block diagram of an example system 100 usable for emoji prediction and visual sentiment analysis. In the implementation shown, the system 100 includes a training system 110, an application system 120, and a model datastore 130. Also shown in FIG. 1 is an annotated image datastore 140 and an input image 150, both of which may be components of or generated by the system 100 or may be separate from or generated independently from the system 100.

In some implementations, the system 100 may generate an emoji embedding for an input image. The emoji embedding may include a vector of values generated using a machine learning model, such as an embedding model 132 from the model datastore 130, where each of the values in the vector correspond to an emoji. The values may, for example, be numeric or Boolean values that correspond to a prediction of whether the emoji is associated with or appropriate for the input image 150. The embedding may be used to predict emoji for the input image (e.g., for use in captioning the image). The embedding may also be used for sentiment analysis. For example, a machine learning model, such as an emoji-to-sentiment model 134 from the model datastore 130, may generate sentiment information based on the emoji embedding of the input image (e.g., without reference to the input image 150). The sentiment information may include a classification of the image as representing one or more specific sentiments. The sentiment information may include a sentiment embedding (e.g., a vector of values representing predictions of various sentiments for the input image 150 based on its emoji embedding).

The training system 110 generates trained machine learning models, such as the emoji embedding model 132 and the emoji-to-sentiment model 134. In some implementations, the machine learning models generated by the training system 110 may be stored in the model datastore 130. In some implementations, the training system 110 may learn an efficient and low-dimensional embedding of images in the emoji space. This embedding may be well aligned with and encode the visual sentiment exhibited in an image. Moreover, this embedding may be learned efficiently from large-scale and weakly labeled data.

In some implementations, the training system 110 includes a training corpus generator 112 and a model trainer 116. The training corpus generator 112 may generate a training corpus 114, which may be used by the model trainer 116. The training corpus generator 112 may generate the training corpus 114 from an annotated image datastore 140.

In some implementations, the annotated image datastore 140 is a datastore of social media data that includes images with associated annotations, which may include emoji. The associated annotations may not expressly describe the image but may be associated with or may accompany the image. In some implementations, the social media data includes images posted to a social media sites, such as the TWITTER social media site, and the accompanying text (e.g., TWEETS). The annotated image datastore 140 may also include posts to other social media sites such as the FACEBOOK social media site, the INSTAGRAM social media site, the FLICKR social media site, and the like. Emojis, with the advent of social media, became a prevailing medium to emphasize emotions, such as happiness, anger, or fear, in communications. Not only do emojis often carry a clear sentiment signal by themselves, they also act as sentiment magnifiers or modifiers of surrounding text. Additionally, due to their prominent use in social media, a large amount of data that includes emoji is readily available without the need for any manual labeling.

Although social media provides a large amount of data on emoji use, the interaction among emojis and the corresponding images in social media remains elusive. Determining whether a strong correlation exists between an emoji and a visual signal and whether emojis capture the visual sentiment exhibited in images is not straightforward.

Social media data is known to be noisy, and the use of emojis is influenced by the user's cultural background and major temporal events. These hurdles represent important challenges to learning an effective emoji representation that can generalize well across domains. In some implementations, the training corpus generator 112 selects or filters data from the annotated image datastore 140 to address or reduce the impact of these concerns with social media data.

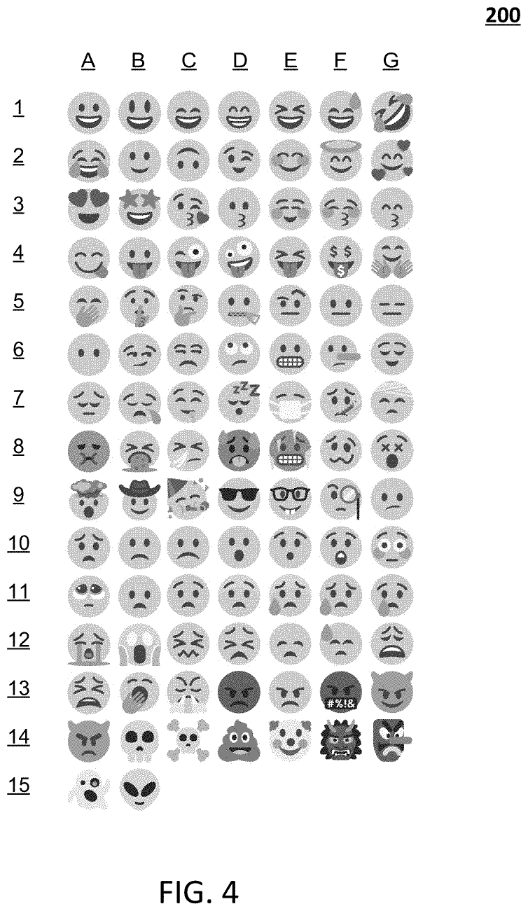

For example, the training corpus generator 112 may select data from the annotated image datastore 140 based on whether the associated annotations include emoji, or whether the associated annotations include specific emoji. In some implementations, the training corpus generator 112 selects a set of a pre-determined number of images that have annotations containing a specific emoji for a subset emojis that are associated with expression of sentiment. An example subset of emoji that may commonly be associated with expression of sentiment is shown in FIG. 4.

The training corpus generator 112 may also filter certain images from the image datastore 140, such as images that have annotations that include hashtags or URLs. Images that have hashtags may not have a strong relationship between the emoji in the annotation and the image (e.g., the emoji may relate to the hashtag or the URL rather than the image). The training corpus generator 112 may also apply a filter to reduce redundancy (e.g., by excluding image data that was posted as quote or reply). In some implementations, annotated images that include more than a threshold number of emoji are also filtered out (e.g., more than 5 emoji).

Additionally, in some implementations, the training corpus generator 112 uses temporal sampling to select data from the image datastore 140. For example, the training corpus generator 112 may select a specific number of images posted during specific time intervals (e.g., each week, 15-day window, or month during the preceding year). In an example implementation, the training corpus generator 112 selects 4000 annotated images from each 30-day window over a 2.5-year time frame. Beneficially, temporal sampling may reduce bias in the training corpus from a few major temporal events (e.g., elections, sporting events, etc.), which may otherwise reduce variability of the image data in the training corpus and ability of a model trained on the corpus to generalize well across domains.

The training corpus 114 is a corpus of training data that is usable by the model trainer 116 to train (or generate) machine learning models. In some implementations, the training corpus 114 includes a first set of training data that includes emoji-annotated image data and a second set of training data that includes sentiment labeled image data. The first set of training data may include more training data than the second set of training data. In some implementations, the first set of training data is an order of magnitude larger than the second set of training data (e.g., the first set of training data may include approximately 10×, 100×, or 1000× more training data than the second set of training data). The first set of training data may be generated by the training corpus generator 112.

The second set of training data may be generated manually (e.g., by human reviewers assigning one or more sentiment values to training images of the second set of training data). In some implementations, multiple human reviewers assign sentiment values to the image data of the second set of training data. For example, the image data may be associated with a sentiment label only when at least a specific percentage of the human reviewers agree that the sentiment label is appropriate. As another example, a numeric value (e.g., a certainty score) may be associated with a sentiment annotation based on the amount of agreement between human reviewers that the annotation is appropriate for the image data.

The model trainer 116 trains one or more machine learning models, such as the emoji embedding model 132 and the emoji-to-sentiment model 134. The model trainer 116 may perform a training procedure to train a machine learning model using training data from the training corpus 114. In some implementations, the model trainer 116 performs data augmentation during training. For example, the model trainer 116 may randomly select image crops of a specific size (e.g., 224×224 pixels or another size) from the images in the training data. Further, the image crops may be randomly flipped, scaled, or otherwise transformed. Some benefits of randomly selecting data crops include that the model may learn to predict emoji based on parts of the image, and model may be trained to more robustly handle to similar images that are positioned or oriented differently.

In some implementations, the model trainer 116 may repeatedly adjust parameters of the machine learning model so as to reduce (or minimize) the difference between the output of the model on the training data and the expected output based on the labels associated with the training data. For example, the model trainer 116 may use stochastic gradient descent (e.g., back propagation, i.e., backward propagation of errors) or variants thereof, such as the Adam optimizer, to iteratively adjust the weighting parameters for layers of a machine learning model such as a neural network model. Examples of neural network models that may be used in various implementations include convolutional neural networks, residual neural networks, and other types of artificial neural networks. In some implementations, a predetermined number of training iterations are performed (e.g., 320,00) or another number. Each iteration may include some or all of the training images (or image crops). For example, in some implementations, each iteration uses 128 images (or image crops) from the training data. In some implementations, the training continues until a convergence or error threshold is reached.

The model datastore 130 may store machine learning models generated by the model trainer 116, such as the emoji embedding model 132 and the emoji-to-sentiment model 134. The emoji embedding model 132 and the emoji-to-sentiment model 134 may be neural network models that were trained using data from the training corpus 114. For example, the emoji embedding model 132 may be a machine learning model. An example of a machine learning model is an artificial neural network model. In some implementations, the machine learning model includes a deep neural network. A deep neural network is a neural network having at least three layers. In some implementations, a deep neural network has ten layers, twenty layers, fifty layers, or a different number of layers. The layers of the neural network may include fully connected layers, convolutional layers, residual layers, and recurrent layers. A residual layer receives input values from a preceding layer in the network that does not immediately precede the residual layer (e.g., a residual layer K in the neural network may receive inputs from both a preceding layer (i.e., layer K−1) and a layer that precedes the preceding layer (i.e., layer K−2)). As used herein, a residual neural network is an artificial neural network having at least one residual layer. In at least one implementation, the emoji embedding model 132 includes a deep residual neural network model (e.g., a 50-layer residual neural network).

The application system 120 is a system that performs various applications that may use results of one or more of the emoji embedding model 132 or the emoji-to-sentiment model 134. In some implementations, the application system 120 includes an emoji predictor 122, a sentiment analyzer 124, and applications 126.

The emoji predictor 122 applies the emoji embedding model 132 to the input image 150 to generate emoji embeddings. In some implementations, the emoji embeddings are then used to generate emoji predictions for the input image 150. For example, the emoji predictions may be generated by selecting all emoji values in the embedding that exceed a predetermined threshold value. In some implementations, a predetermined number of emojis are selected as predictions based on the scores (e.g., the top five emojis are selected).

The sentiment analyzer 124 applies the emoji-to-sentiment model 134 to an emoji embedding to determine one or more sentiment values for the emoji embedding. For example, the sentiment analyzer 124 may generate a sentiment embedding for an emoji embedding. The sentiment embedding may be a vector of values, where each value corresponds to a specific sentiment and is based on the emoji-to-sentiment model's prediction of whether the sentiment applies to the input emoji embedding. In some implementations, the sentiment embedding may include relatively few values, such as positive, neutral, or negative. In other implementations, the emoji embedding may include more fine-grained sentiment such as happiness, sadness, fear, and other emotions or sentiments.

In some implementations, the emoji predictor 122 and the sentiment analyzer 124 are combined in an image-to-sentiment system that determines a sentiment for an input image by generating an intermediate emoji embedding for the input image.

The applications 126 includes various applications that use one or more of the emoji predictions from the emoji predictor 122 or the sentiment values from the sentiment analyzer 124. In some implementations, the applications 126 include a captioning system that generates suggested captions for the input image 150 based on one or more of the predicted emojis from the emoji predictor 122 and the determined sentiment from the sentiment analyzer 124. In some implementations, the applications 126 include a content filtering system that filters or flags content based on the emoji embedding or predicted sentiment (e.g., to flag potentially violent or abusive images). In some implementations, the applications 126 include a sentiment-aware image search system that searches for images that match a specified sentiment. In some implementations, the applications 126 include a targeted advertising system that, with user consent, targets advertisements to a user of a social media system based on the determined sentiment of images the user posts or with which the user interacts.

Although FIG. 1 shows several different systems and data stores, it should be understood that these are logical components and they are not necessarily separate systems. These components may be separate systems in some implementations. But in some implementations, several or all of the components of FIG. 1 may be combined into a single system. Further, some of the components shown in FIG. 1 may be divided across several distributed computing systems.

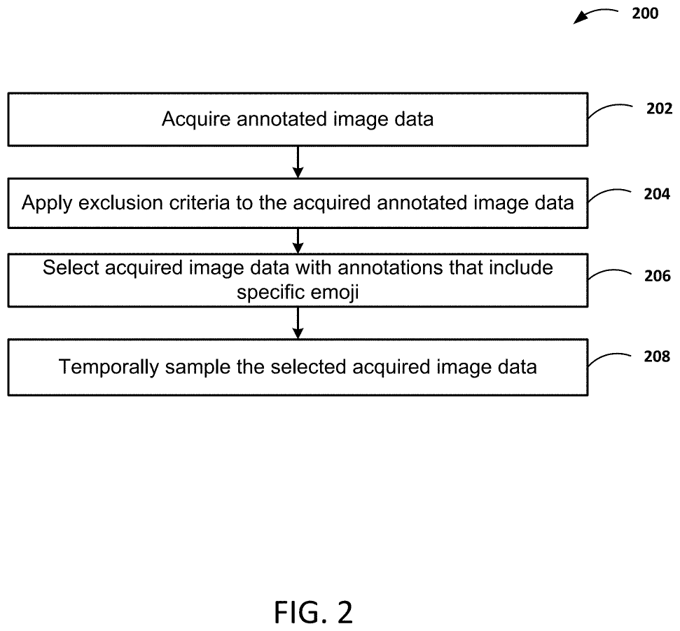

FIG. 2 illustrates a block diagram of a method 200 according to at least one example implementation. For example, the method 200 can be implemented by the training corpus generator 112. The method 200 may be used to collect training data from a social media source or elsewhere. This collected training may be used as a training corpus such as the training corpus 114.

At operation 202, annotated image data is acquired. As described above, the annotated image data may be acquired from social media. The annotations may, for example, include user comments or descriptions that accompany an image in a social media post.

Social media such as the INSTAGRAM social media site, the FACEBOOK social media site, the FLICKR social media site, and the TWITTTER social media site represent a rich source for large-scale emoji data. It is estimated that more than 700 million emojis are sent daily over the FACEBOOK social media site while half the posts in Instagram contains emojis. In an example, the annotated image data is acquired from the TWITTER social media site (e.g., TWEETS that contain emojis and are associated with at least one image).

At operation 204, exclusion criteria are applied to the acquired image data. The exclusion criteria may remove annotated image data in which the relationship between the emoji and the image may not be strong. For example, in some implementations, annotated image data that includes URLs, hashtags, or user mentions are excluded (e.g., as the emoji may relate to the URL, hashtag, or user mention rather than the image). Additionally, these elements may represent important context cues to understand the use of the associated emoji that goes beyond the associated visual data (or image). Additionally, at least some implementations also exclude posts that are quotes or replies to other posts to reduce redundancy. Furthermore, some implementations exclude posts with annotations that include more than a predefined number of emojis (e.g., posts have more than 5 emoji may be excluded).

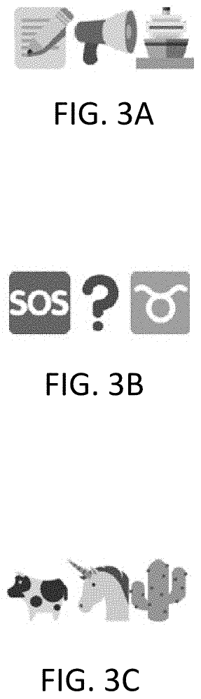

At operation 206, image data with annotations that include specific emoji are selected from the acquired image data. The emoji list has grown from 76 entries in 1995 to 3019 in the latest Emoji v12.0 in 2019. Many of these emojis represent objects categories (e.g., a pencil, bullhorn, or ship, for example, as shown in FIG. 3A), abstract concepts (e.g., SOS/help, Zodiac symbols, or a question mark, for example, as shown in FIG. 3B) or animals and plants (e.g., a cow, unicorn, or cactus, as shown in FIG. 3C). These types of emojis are either sentiment neutral or have weak correlation with sentiment that usually arise from users' cultural background or personal preferences, e.g., towards certain animal classes. Since the annotated image data may be used in training a model for sentiment analysis of images or visual data, these types of emoji are excluded from selection in at least some embodiments.

Instead, a subset of emojis that are more likely to be associated with sentiment or emotion are used in selecting annotated image data. In some implementations, a subset of 92 popular emojis that are commonly referred to as Smileys are used as targets. FIG. 4 shows an example of emojis that includes at least some of the Smileys (e.g., angry face at 12G, happy face at 1D, and crying face at 12A). The Smileys often show a clear sentiment or emotional signal which may make them adequate for cross-domain sentiment analysis. Moreover, the Smileys are among the most frequently used emojis in social media, which further facilitates data collection and aids the learning process. Some implementations use fewer, more, or different emoji as targets. In some implementations, annotated image data is selected if the annotation includes at least one of the target emojis.

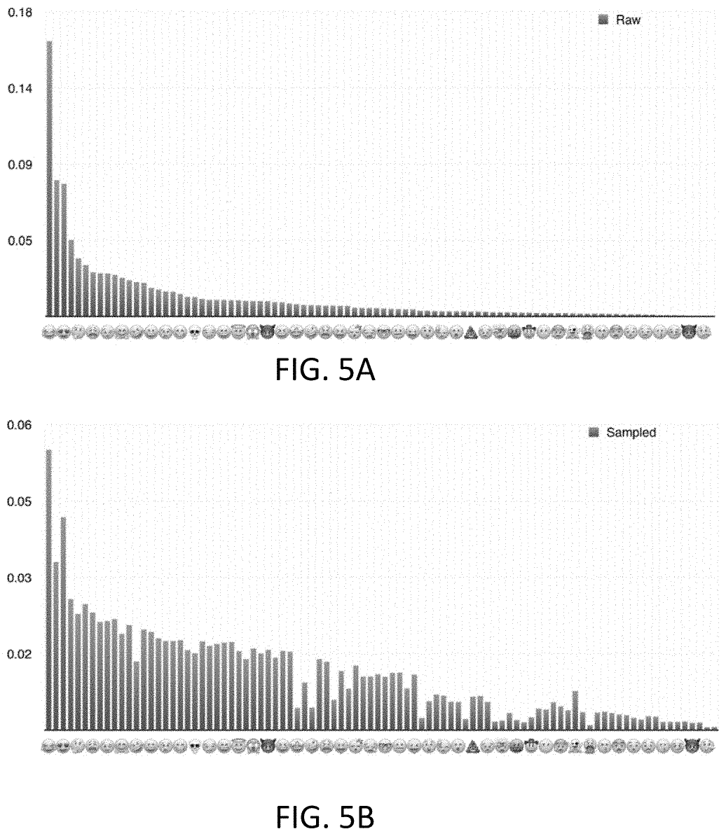

In an example implementation, a collection of 2.8 million Tweets from the first six months of 2018 was selected. A graph of the percentage of selected tweets that include each of the selected emoji is shown in FIG. 5A. As can be seen, the graph has a long-tail distribution and is heavily biased towards a few emoji. In fact, the top 5 most frequent of the selected emojis (i.e., “face with tears of joy”-emoji (shown at 2A in FIG. 4), “loudly crying face”-emoji (shown at 12A in FIG. 4), “smiling face with heart-eyes”-emoji (shown at 3A in FIG. 4), “smiling face with smiling eyes”-emoji (shown at 2E in FIG. 4), and “thinking face”-emoji (shown at 5C in FIG. 4)) represent around 40% of the retrieved selected tweets. This imbalance may pose a challenge for many machine learning methods as an imbalanced training dataset may lead a training process to trivially predict the most frequent labels instead of learning a more meaningful representation (or embedding).

At operation 208, the selected acquired image data is temporally sampled. Temporally sampling the acquired image data may include dividing a longer time period into shorter sub-periods or time windows. The longer time period may be a month, several months, a year, or even several years. The longer time period may be defined based on a current date and a specific duration of time. The specific duration of time may be based on user input. The shorter time windows may have a uniform duration. For example, the shorter time windows may have a duration of 1 day, 5 days, 7 days, 10 days, 30 days, or another duration. In some implementations, the duration of the shorter time windows is determined by dividing the longer time period into a specific number of equal duration time windows. Temporally sampling the selected acquired image data may include selecting (or identifying) sample data from multiple (at least two) or all of the shorter time windows.

For example, annotated image data posted over a relatively large time period may sampled uniformly from smaller time windows within the larger time period. For example, a specific number of annotated images posted during each 30-day time window within a longer multi-year time period may be selected. In some implementations, a specific number of annotated images posted during each 30-day time window are identified that include a specific emoji. For example, 4000 annotated images that were posted during each time window may be selected for each of the target emojis. By selecting annotated images that include each of the target emojis, the training dataset may be better balanced and may include sufficient data to train for each of the target emojis.

As one example, tweets from a larger time period of Jan. 1, 2016, through Jul. 31, 2018, are selected. This larger time period is split into sequential time windows of 30 days. From within each of the 30-day windows, a maximum of 4000 tweets for each emoji are selected. In total, this methodology leads to about 4 million images with 5.2 million emoji labels. FIG. 5B shows a graph of the percentage of selected tweets that included each of the selected emoji is shown. As can be seen by comparing the graphs in FIG. 5A and FIG. 5B, the distribution is more balanced when temporal sampling is used.

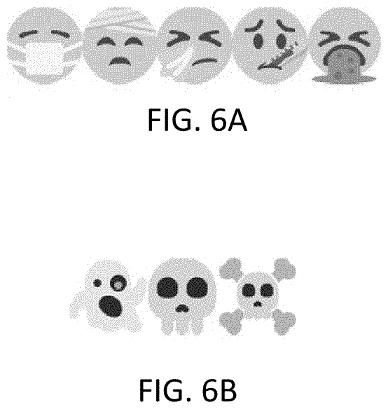

Nonetheless, some emojis still occur relatively more often than others due to the multi-label nature of the data and the innate inter-emoji correlations. In some implementations, a normalized correlation matrix of all emojis in the collected data is constructed. In the example data shown in FIG. 5B, the correlation matrix showed that the two most frequently occurring emojis “face with tears of joy”-emoji (shown at 2A in FIG. 4) and “smiling face with heart-eyes”-emoji (shown at 3A in FIG. 4) co-occur with most of the other emoji. Additionally, the correlation matrix showed some semantically related groups like the sickness-related emojis shown in FIG. 6A and the ghost/skull-related emojis shown in FIG. 6B.

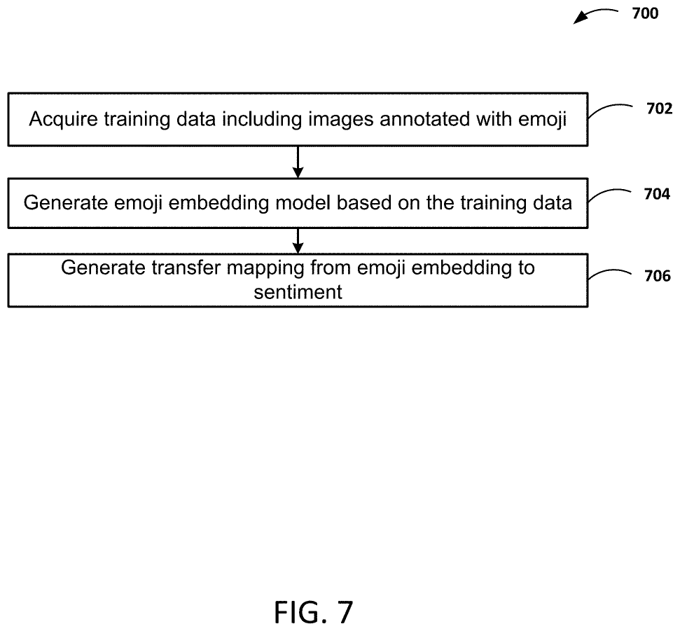

FIG. 7 illustrates a block diagram of a method 700 according to at least one example implementation. For example, the method 700 can be implemented by the model trainer 116. The method 700 may be used to train one or more models usable in analyzing sentiment in images, such as the emoji embedding model 132 or the emoji-to-sentiment model 134.

At operation 702, training data is acquired. The training data may for example include images that are annotated with associated emoji. The training data may for example be acquired from the training corpus 114. In some implementations, the training data may be generated by a method similar to the method 200. As described above, the training data may include several million images with associated emoji.

At operation 704, an emoji embedding model is generated based on the acquired training data. In implementations that use a large set of training data, it is possible to leverage deep neural network architectures for effective learning of the emoji embedding with reduced risks of data overfitting. Formally, the goal of the learning process may be to learn an embedding function f(⋅) that maps an image xϵX^{d}^{ₓ} to an embedding in the emoji space eϵε^{d}^{ₑ}, i.e., f: X^{d}^{_{x→ε}}^{d}^{ₑ}, where dₓ and dₑ are the dimensionality of the image and emoji spaces respectively.

In some implementations, the emoji embedding is implemented through the task of explicit emoji prediction. In some implementations, this emoji prediction approach may have several benefits compared to other approaches such as metric learning in the emoji space. First, the network architectures used for emoji prediction may be computationally more efficient compared to Siamese and Triplet network architectures that are usually employed for metric learning. Hence, emoji prediction may more readily scales to large datasets while using less resources. Second, the learned embedding through the emoji prediction task is interpretable since each dimension in e corresponds to one of the selected emojis, i.e., dₑ=C where C is the number of selected emojis. This may enable subsequent analysis of the embedding and better understanding of model properties.

In at least some implementations, an emoji prediction model h(⋅) is trained such that h(x)=σ(f(x)), where σ is the sigmoid activation function since emoji prediction can be a multi-label classification problem. Then h(⋅) may be optimized using the binary cross entropy loss:

$$ℒ ( {x}_{i} , {y}_{i} ) = - {\sum }_{c = 1}^{C} {y}_{i , c} log ( {h ( {x}_{i} )}_{c} ) ,$$

where y_{i,c} is the corresponding binary label for the emoji c, and h(xᵢ)c is the probability of the model predicting emoji c for image xᵢ. In at least some implementations, the emoji prediction model is trained iteratively. For example, parameters of the model may be adjusted after each iteration using stochastic gradient descent.

At operation 706, a transfer mapping is generated from the emoji embedding to sentiment data. Once f(⋅) is trained, the model may be adapted across domains for a target task g(⋅) such as sentiment or emotion prediction. In some implementations, this adaptation is achieved through a transfer mapping t(⋅) that maps the emoji embedding to the target label space T, such that g=t∘ƒ:X→E→T where t(⋅) is realized using a multilayer perceptron and g(⋅) can then be learned using a small training data of the target task. For example, g(⋅) may be learned using a small training data set of emoji embeddings to sentiment. These emoji embeddings to sentiment data may be generated from images that have been labeled with sentiment values.

Some implementations use a zero-shot visual sentiment prediction methodology. A zero-shot visual sentiment prediction methodology is a methodology in which no training data is used to map from the emoji embedding to sentiment values. Because the emoji embedding is interpretable, each dimension can be related to a certain sentiment class (e.g., “face with tears of joy”-emoji (shown at 2A in FIG. 4) and “smiling face with heart-eyes”-emoji (shown at 3A in FIG. 4) can be related to a positive sentiment class without using sentiment training data). For example, one or more human annotators may specify whether certain emoji are associated with specific sentiments, which can be combined with the emoji embedding of an image to analyze the sentiment of the image.

For example, a small number (e.g., 4, 5, 6, etc.) of human annotators may label each emoji in the emoji embedding with a positive or negative sentiment based solely on the emoji's visual depiction. The average annotation is then used as a mapping t(⋅) to ensemble the emoji's prediction scores to estimate whether an image has a positive or a negative sentiment. Even without using any training images that are labeled with sentiment, this example implementation is still capable of producing reliable sentiment prediction that is competitive with many state-of-the art sentiment prediction models.

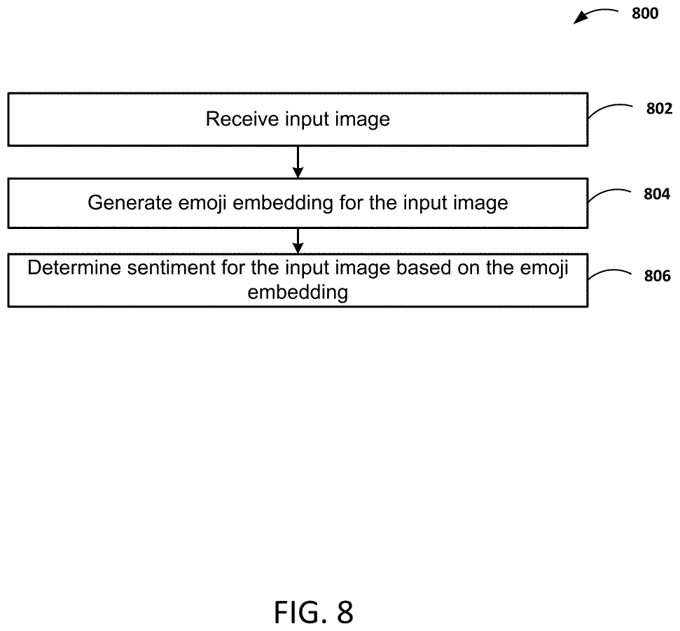

FIG. 8 illustrates a block diagram of a method 800 according to at least one example implementation. For example, the method 800 can be implemented by an image-to-sentiment system of the application system 120 (e.g., a combination of the emoji predictor 122 and the sentiment analyzer 124). The method 800 may be used to determine sentiment for an input image using one or more of the emoji embedding model 132 and the emoji-to-sentiment model 134.

At operation 802, an input image is received. In some implementations, multiple input images are received. The input image may be received from one of many sources. For example, the input image may be received from a local data storage device. The input image may also be received from a network storage device. In some implementations, the input image is received from a camera device. In some implementations, the input image is received based on a user input. For example, a user may select an image from a file system for sentiment determination as described herein. As another example, the user may select an image for posting to social media and the sentiment of the image may be determined for the selected image. As another example, the image may be received based on the user selecting a social media post that includes an image. The user may select the post by viewing the post, quoting from, replying to, otherwise indicating or identifying the post. In some implementations, the input image may retrieved from a social media data store. For example, some or all images posted to a social media site may be retrieved so as to perform sentiment trend analysis.

At operation 804, an emoji embedding is generated for the input image. The emoji embedding may, for example, be generated by applying the emoji embedding model 132 to the input image. In some implementations, the pixel dimension of the input image may be adjusted. For example, the input image may be down-sampled to a lower resolution or interpolated to increase the resolution. The input image may also be scaled, cropped, or otherwise transformed before the emoji embedding model 132 is applied to it. As described elsewhere, the emoji embedding may be a vector of numeric or Boolean values that each correspond to a specific emoji. The emoji embedding may represent the image as a weighted combination of emojis. Higher numeric or True Boolean values in the vector may indicate that the associated emoji is likely relevant to the input image.

In some implementations, one or more predicted emoji are generated for the input image based on the emoji embedding. For example, the one or more predicted emoji may be generated by selecting the emoji associated with the highest values in the emoji embedding. As another example, the one or more predicted emoji may be generated based on selecting emoji associated with numeric values in the emoji embedding that exceed a threshold value.

At operation 806, a sentiment is determined for the input image based on the emoji embedding. The sentiment may be determined by applying the emoji-to-sentiment model 134 to the emoji embedding. Applying the emoji-to-sentiment model 134 to the emoji embedding may generate a vector of numeric values or Boolean values, each of which correspond to a specific sentiment where higher or true values mean the sentiment is more likely or more associated with the input image. In some implementations, the output vector may have relatively few values and a coarse sentiment value is determined (e.g., positive, negative, or neutral). In other implementations, the output vector may have more values and a more fine-grained sentiment value is determined (e.g., happy, sad, angry, scared, etc.). In some implementations, more than one sentiment may be determined for an input image based on the determined emoji embedding. In some implementations, a single sentiment is determined for an image (e.g., by selecting the sentiment associated with the highest value in the output vector. Multiple sentiments may be determined for an image by selecting the sentiments associated with the highest values in the output vector.

As described further elsewhere herein, the emoji-to-sentiment model 134 may be trained using training images with labeled sentiments. In some implementations, the emoji-to-sentiment model 134 is a zero-shot model that is not trained using labeled images. Instead, the zero-shot model may be based on inferred sentiment from the appearance of emoji (e.g., a happy face emoji is associated with a positive sentiment). The zero-shot model may be based on input from one or more human reviewers or even from textual descriptions of the emoji.

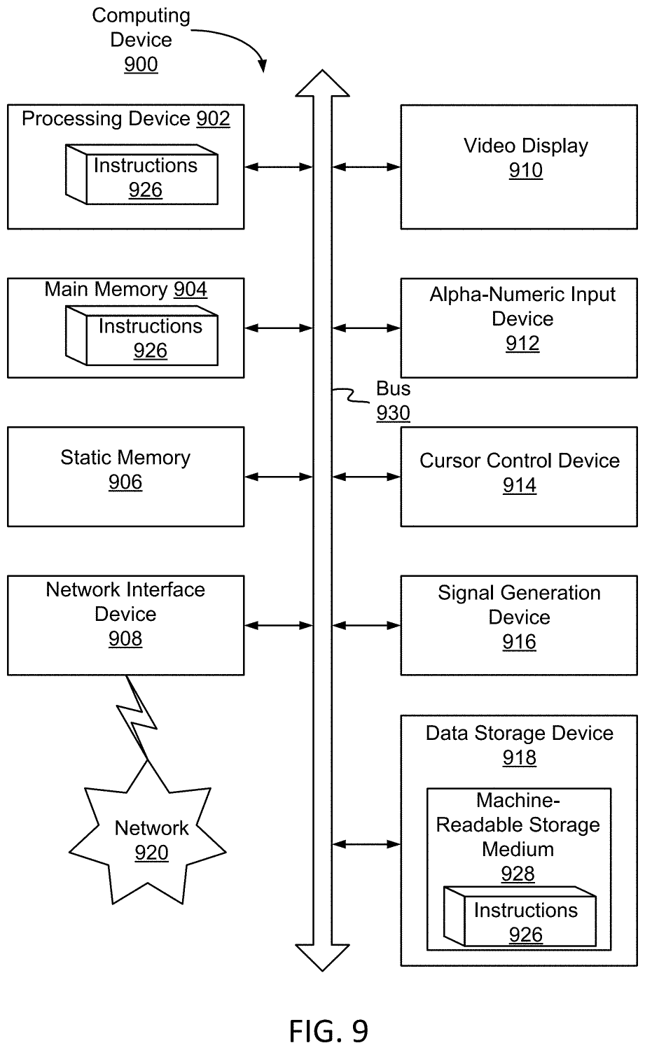

FIG. 9 illustrates a diagrammatic representation of a machine in the example form of a computing device 900 within which a set of instructions, for causing the machine to perform any one or more of the methodologies discussed herein, may be executed. The computing device 900 may be a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methodologies discussed herein, may be executed. In one implementation, the computing device 900 may present various user interfaces to a user. The user interfaces may include an input field through which the user may specify image data. The user interface may display or include information derived using the techniques described herein. For example, the user interface may include suggested emoji for an image based on generating an emoji embedding as described herein. As another example, the interface may include a description of a sentiment determined for the image as described herein.

In alternative implementations, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computing device 900 includes a processing device (e.g., a processor) 902, a main memory 904 (e.g., read-only memory (ROM), flash memory, dynamic random access memory (DRAM) such as synchronous DRAM (SDRAM)), a static memory 906 (e.g., flash memory, static random access memory (SRAM)) and a data storage device 918, which communicate with each other via a bus 930.

Processing device 902 represents one or more general-purpose processing devices such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 902 may also be one or more special-purpose processing devices such as an application specific integrated circuit (ASIC), a field programmable gate array (FPGA), a digital signal processor (DSP), network processor, or the like. The processing device 902 is configured to execute instructions 926 (e.g., instructions for an application ranking system) for performing the operations and steps discussed herein.

The computing device 900 may further include a network interface device 908 which may communicate with a network 920. The computing device 900 also may include a video display unit 910 (e.g., a liquid crystal display (LCD) or a cathode ray tube (CRT)), an alphanumeric input device 912 (e.g., a keyboard), a cursor control device 914 (e.g., a mouse) and a signal generation device 916 (e.g., a speaker). In one implementation, the video display unit 910, the alphanumeric input device 912, and the cursor control device 914 may be combined into a single component or device (e.g., an LCD touch screen).

The data storage device 918 may include a computer-readable storage medium 928 on which is stored one or more sets of instructions 926 (e.g., instructions for the application ranking system) embodying any one or more of the methodologies or functions described herein. The instructions 926 may also reside, completely or at least partially, within the main memory 904 and/or within the processing device 902 during execution thereof by the computing device 900, the main memory 904 and the processing device 902 also constituting computer-readable media. The instructions may further be transmitted or received over a network 920 via the network interface device 908.

While the computer-readable storage medium 928 is shown in an example implementation to be a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media and magnetic media. The term “computer-readable storage medium” does not include transitory signals.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. Various implementations of the systems and techniques described here can be realized as and/or generally be referred to herein as a circuit, a module, a block, or a system that can combine software and hardware aspects. For example, a module may include the functions/acts/computer program instructions executing on a processor (e.g., a processor formed on a silicon substrate, a GaAs substrate, and the like) or some other programmable data processing apparatus.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more processors, Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium, non-transitory computer readable storage medium and/or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A computer-implemented method comprising:
receiving an image;
generating an emoji embedding for the image; and
generating a sentiment label for the image based on the emoji embedding.

2. The method of claim 1, wherein the generating an emoji embedding for the image includes applying an emoji embedding model to the image.

3. The method of claim 2, wherein the emoji embedding model is a machine learning model.

4. The method of claim 3, wherein the machine learning model includes a deep residual neural network having at least ten layers.

5. The method of claim 3, wherein the machine learning model is generated using a training process on a corpus of annotated image data that includes images annotated with at least one emoji.

6. The method of claim 5, wherein the corpus of annotated image data is generated automatically from social media data.

7. The method of claim 1, wherein the emoji embedding is represented by a vector of values, the different values of the vector corresponding to different emojis.

8. The method of claim 1, wherein the generating a sentiment label for the image based on the emoji embedding includes determining a positive, negative, or neutral sentiment value for the image.

9. The method of claim 1, wherein the generating a sentiment label for the image based on the emoji embedding includes applying an emoji-to-sentiment model to the emoji embedding.

10. The method of claim 9, wherein the emoji-to-sentiment model is generated using a training process on a corpus of labeled image data that includes images annotated with at least one sentiment value.

11. The method of claim 9, wherein the emoji-to-sentiment model is zero-shot model that is generated without use of training images.

12. The method of claim 1, further comprising generating a suggested caption for the image based on the emoji embedding.

13. The method of claim 1, further comprising triggering display of an indication of the determined sentiment label for the image.

14. A system comprising:
at least one memory including instructions; and
at least one processor that is operably coupled to the at least one memory and that is arranged and configured to execute instructions that, when executed, cause the at least one processor:
acquire annotated image data;
apply exclusion criteria to the acquired annotated image data;
select acquired image data with annotations that include specific emoji; and
temporally sample the selected acquired image data.

15. The system of claim 14, wherein the instructions that, when executed, cause the at least one processor to acquire annotated image data include instructions to acquire social media posts that include images and emoji.

16. The system of claim 15, wherein the instructions that, when executed, cause the at least one processor to apply exclusion criteria to the acquired annotated image data include instructions to remove social media posts that include uniform resource locators from the acquired annotated image data.

17. The system of claim 15, wherein the social media posts are associated with a date and the instructions that, when executed, cause the at least one processor to temporally sample the selected acquired image data include instructions to:
determine a longer time period;
divide the longer time periods into a plurality of shorter time windows, the plurality of shorter time windows including a first time window and second time window;
identify a predetermined number of social media posts associated with dates occurring in the first time window, the identified social media posts including a specific emoji; and
identify a predetermined number of social media posts associated with dates occurring in the second time window, the identified social media posts including the specific emoji.

18. The system of claim 17, further comprising instructions that cause the system to: train an emoji embedding model using the identified social media posts associated with dates occurring in the first time window and the identified social media posts associated with dates occurring in the second time window.

19. A non-transitory computer readable storage medium including instructions that when executed by at least one processor, cause the at least one processor to:
receive an image;
generate an emoji embedding for the image by applying a machine learning model to the image, the emoji embedding including a vector of values, the different values of the vector corresponding to different emojis; and
predicting at least one emoji for the image based on the emoji embedding.

20. The non-transitory computer readable storage medium of claim 19, wherein the instructions further cause the at least one processor to:
generate a sentiment label for the image using the emoji embedding; and
trigger display of an indication of the sentiment label for the image.
